(19) United States
(12) Patent Application Publication
(10) Pub. No.: US 2009/0309957 A1
(43) Pub. Date: Dec. 17, 2009

(54) OMNIDIRECTIONAL IMAGING APPARATUS

(76) Inventors: Zongtao GE, Saitama-shi (JP); Seiji MOCHITATE, Saitama-shi (JP)

Correspondence Address: BIRCH STEWART KOLASCH & BIRCH, PO BOX 747, FALLS CHURCH, VA, 22040-0747, US

(21) Appl. No.: 12/484,926

(22) Filed: Jun. 15, 2009

(30) Foreign Application Priority Data
Jun. 16, 2008 (JP) P2008-156953

(51) Int. Cl. H04N 7/00

(52) U.S. Cl. 348/36; 348/E07.001

(57) ABSTRACT

Disclosed is an omnidirectional imaging apparatus capable of obtaining substantially the same amount of image data per unit azimuth angle in subject information within the same azimuth angle range, in the entire image region of an omnidirectional image, and forming a high-quality panoramic image over the entire image region.

A line sensor of an imaging unit is rotated on an imaging surface to perform scanning, thereby sequentially acquiring image data of an omnidirectional image in all directions that is formed by an imaging optical system. A panoramic image forming unit forms a panoramic image on the basis of the image data of the omnidirectional image sequentially acquired in all directions.

### CROSS-REFERENCE

The present application claims priority from Japanese Patent Application No. 2008-156953 filed on Jun. 16, 2008, the entire content of which is incorporated herein by reference.

### BACKGROUND OF THE INVENTION

1. Field of the Invention

The present invention relates to an omnidirectional imaging apparatus that captures an omnidirectional image having subject information in all directions radially arranged therein and forms a panoramic image having subject information in all directions arranged in parallel therein on the basis of image data of the omnidirectional image.

2. Description of the Related Art

An omnidirectional imaging apparatus has been proposed which uses an imaging optical system to form an omnidirectional image on an imaging surface of an area sensor (a two-dimensional image sensor) and forms a panoramic image on the basis of image data of the omnidirectional image acquired by the area sensor (see JP-A-2003-308526, JP-A-2005-94713, JP-A-2008-28606, JP-A-2003-250070, and JP-T-2007-531333).

As the imaging optical system, a wide-angle lens (omnidirectional lens), such as a fisheye lens or a panoramic annular lens (PAL, see JP-T-2007-531333), or a curved mirror (omnidirectional mirror) having, for example, a spherical shape, a hyperboloidal shape, or a conic shape has been used in order to focus beams from a subject in all directions.

FIGS. 3A and 3B are diagrams illustrating an example of the correspondence between an omnidirectional image and a panoramic image. FIG. 3A schematically shows an omnidirectional image having subject information of four persons who sit around a round table, which is obtained by an imaging optical system including a curved mirror that is provided on the round table such that its optical axis is parallel to the vertical direction and the curved mirror faces downward, and FIG. 3B schematically shows a panoramic image of the omnidirectional image.

In an omnidirectional image 70 shown in FIG. 3A, subject information in all directions is radially arranged in the diametric direction from the image center C of the omnidirectional image in an annular region (for example, the image of a lens arranged opposite to the omnidirectional mirror is arranged in a central region S₀) (for example, subject information items disposed at azimuth angles θ₁ and θ₂ are arranged on lines L₁ and L₂, respectively).

A panoramic image 80 shown in FIG. 3B is formed such that it has a rectangular shape, the longitudinal direction (which corresponds to the vertical direction of a real space) thereof corresponds to the diametric direction of the omnidirectional image, the lateral direction (which corresponds to the horizontal direction of a real space) thereof corresponds to the circumferential direction of the omnidirectional image, and subject information in all directions is arranged in parallel along the lateral direction (for example, subject information on the lines L₁ and L₂ respectively corresponding to the azimuth angles θ₁ and θ₂ in the omnidirectional image 70 is arranged on lines L₁′ and L₂′ corresponding to the azimuth angles θ₁ and θ₂ in the panoramic image 80).

When the panoramic image 80 is formed on the basis of the image data of the omnidirectional image 70, two image region S₁ and S₂ set in the omnidirectional image 70 are considered. The two image regions S₁ and S₂ have subject information arranged in the same azimuth angle range α. However, since the image region S₁ is closer to the image center C than the image region S₂, the length of the image region S₁ in an azimuthal direction (the circumferential direction of the omnidirectional image 70) is smaller than that of the image region S2 in the omnidirectional image 70.

When the panoramic image 80 is formed on the basis of the image data of the omnidirectional image 70, image data in the two image regions S₁ and S₂ of the omnidirectional image 70 is converted into image data in two image regions S₁′ and S₂′ of the panoramic image 80. In the omnidirectional image 70, the length of the image region S₁ in the azimuthal direction (the circumferential direction of the omnidirectional image 70) is smaller than that of the image region S2. However, in the panoramic image 80, the lengths of the two image regions S₁′ and S₂′ in the azimuthal direction (the lateral direction of the panoramic image 80) are equal to each other.

Therefore, when a general area sensor is used to acquire the image data of the omnidirectional image 70 and the panoramic image 80 is formed on the basis of the image data, the image quality (resolution) of the image region S₁′ is lower than that of the image region S₂′, The reason is that, in a general area sensor in which light receiving elements are arranged with a uniform density, of two image regions S₁ and S₂ of the omnidirectional image 70, the image region S₁ having a small length in the azimuthal direction has a smaller number of corresponding light receiving elements per unit azimuth angle than the image region S₂. That is, assuming that one image data item is obtained by one light receiving element, when a general area sensor is used to capture the omnidirectional image 70, the amount of image data per unit azimuth angle in subject information within the same azimuth angle range greatly varies depending on the position of the image region in the diametric direction in the omnidirectional image 70. For example, in the two image regions S₁ and S₂, the image region S₁ disposed close to the image center C has a smaller amount of image data per unit azimuth angle than the image region S₂ disposed away from the image center C.

### SUMMARY OF THE INVENTION

The invention has been made in order to solve the above-mentioned problems, and an object of the invention is to provide an omnidirectional imaging apparatus capable of obtaining substantially the same amount of image data per unit azimuth angle in subject information within the same azimuth angle range, in the entire image region of an omnidirectional image, when acquiring image data of the omnidirectional image, and forming a high-quality panoramic image over the entire image region.

In order to achieve the above-mentioned object, an omnidirectional imaging apparatus according to an aspect of the invention includes: an imaging optical system that forms an omnidirectional image having subject information in all directions radially arranged therein; an imaging unit that acquires image data of the omnidirectional image formed by the imaging optical system; and a panoramic image forming unit that forms a panoramic image having the subject information in all directions arranged in parallel therein, on the basis of the image data of the omnidirectional image acquired by the imaging unit. The imaging unit includes a line sensor that has a group of light receiving elements arranged in a direction orthogonal to a predetermined rotation axis and can rotate about the predetermined rotation axis to perform scanning. The imaging unit rotates the line sensor to perform scanning, thereby sequentially acquiring the image data of the omnidirectional image in all directions. The panoramic image forming unit forms the panoramic image on the basis of the image data of the omnidirectional image that is sequentially acquired in all directions by the imaging unit.

The imaging optical system may include a wide-angle lens that refracts beams incident in all directions and focuses the refracted beams. Alternatively, the imaging optical system may include a curved mirror that reflects beams incident in all directions and focuses the reflected beams.

The line sensor may have the predetermined rotation axis provided at the center thereof in a direction in which the light receiving element group is arranged.

The imaging unit may include: a fixed portion; a driving motor that is provided in the fixed portion; and a rotating portion that is fixed to a rotating shaft of the driving motor so as to be rotated with respect to the fixed portion. The line sensor may be held by the rotating portion, and light may be used for the supply of power to the line sensor and the transmission of signals from the line sensor.

In the above-mentioned aspect, the line sensor includes only one row of a plurality of light receiving elements (light receiving element group) arranged in a straight line. However, a line sensor including a plurality of rows of light receiving element groups arranged in straight lines in parallel to each other may be used.

The omnidirectional imaging apparatus according to the invention having the above-mentioned structure can obtain the following effects.

That is, the omnidirectional imaging apparatus according to the invention rotates the line sensor including a group of light receiving elements arranged in a direction orthogonal to a predetermined rotation axis to perform scanning, thereby sequentially acquiring image data of a formed omnidirectional image in all directions, and forms a panoramic image on the basis of the image data sequentially acquired in all directions.

It is possible to obtain substantially the same amount of image data per unit azimuth angle in subject information within the same azimuth angle range, regardless of the position of an image region in the omnidirectional image, by rotating the line sensor to perform scanning to sequentially acquire the image data of the omnidirectional image in all directions. Therefore, it is possible to form a high-quality panoramic image over the entire image region.

### BRIEF DESCRIPTION OF THE DRAWINGS

FIG. 1 is a diagram schematically illustrating the structure of an omnidirectional imaging apparatus according to a first embodiment of the invention;

FIG. 2 is a diagram schematically illustrating the structure of an omnidirectional imaging apparatus according to a second embodiment of the invention;

FIGS. 3A and 3B are diagrams schematically illustrating the correspondence between an omnidirectional image (FIG. 3A) and a panoramic image (FIG. 3B);

FIG. 4 is a diagram schematically illustrating the structure of an imaging unit; and

FIG. 5 is a diagram illustrating another example of the setting of the rotating axis of a line sensor.

### DESCRIPTION OF THE PREFERRED EMBODIMENTS

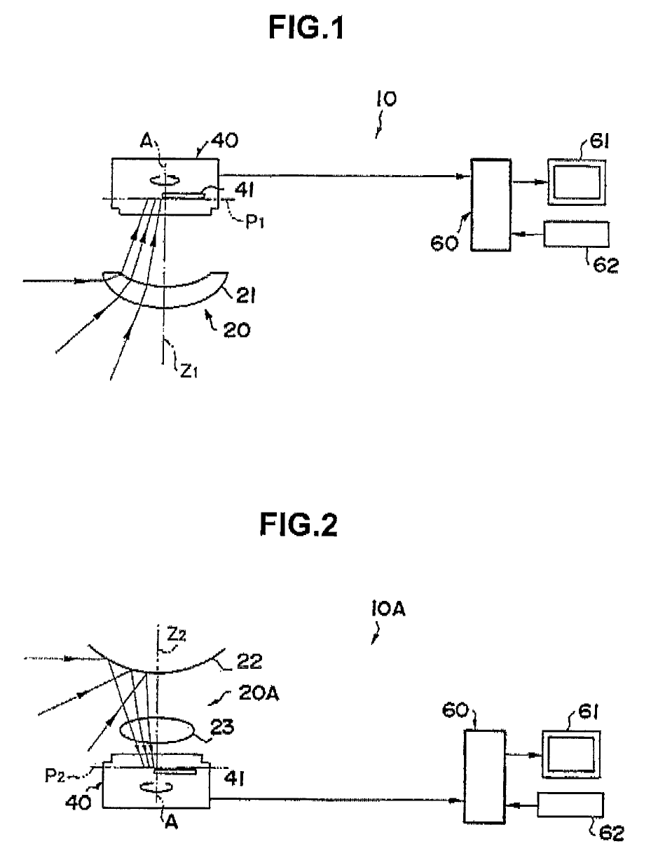

Hereinafter, exemplary embodiments of the invention will be described in detail with reference to the accompanying drawings. FIG. 1 is a diagram schematically illustrating the structure of an omnidirectional imaging apparatus according to a first embodiment of the invention.

An omnidirectional imaging apparatus 10 shown in FIG. 1 includes an imaging optical system 20 that forms an omnidirectional image having subject information radially arranged in all directions, an imaging unit 40 that acquires image data of the omnidirectional image formed by the imaging optical system 20, a panoramic image forming unit 60 that is composed of, for example, a computer and forms a panoramic image having subject information in all directions arranged in parallel to each other therein, on the basis of the image data of the omnidirectional image acquired by the imaging unit 40, a display device 61 that displays the image or the analysis result obtained by the panoramic image forming unit 60, and an input device 62 including, for example, a keyboard or a mouse.

The imaging optical system 20 includes a wide-angle lens 21, such as a fisheye lens or a panorama annular lens, that refracts and focuses beams incident in all directions, and forms an omnidirectional image on an imaging surface P₁ using the beams focused by the wide-angle lens 21.

The imaging unit 40 includes a line sensor 41 that includes a group of light receiving elements (not shown) arranged in a line in a direction that is orthogonal to a predetermined rotating axis A (which is aligned with an optical axis Z₁ of the imaging optical system 20) and can rotate about the rotating axis A to perform scanning. The imaging unit 40 sequentially acquires the image data of the omnidirectional image in all directions while rotating the line sensor 41 on the imaging surface P₁ to perform scanning.

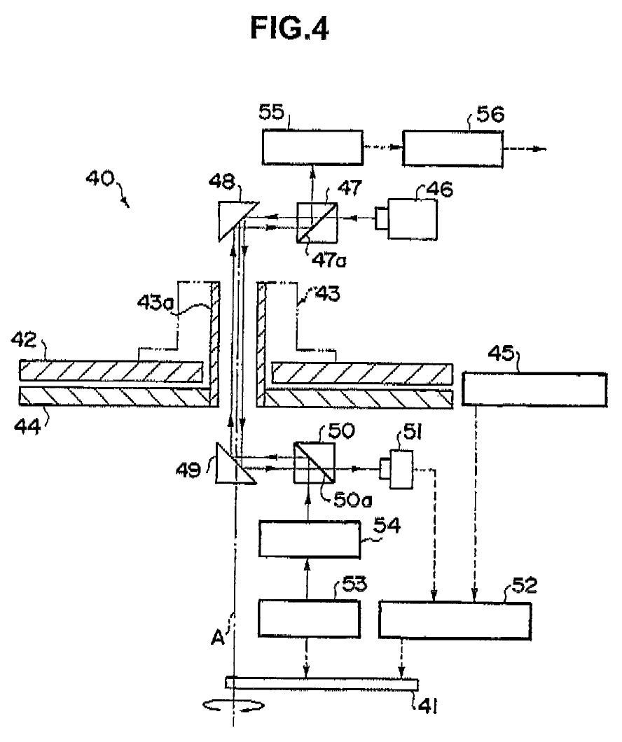

Next, the structure of the imaging unit 40 will be described in more detail with reference to FIG. 4. FIG. 4 is a diagram schematically illustrating the structure of the imaging unit 40. As shown in FIG. 4, the imaging unit 40 includes a fixed portion 42 that is fixed to a case (not shown), a driving motor 43 that is provided in the fixed portion 42, a rotating portion 44 that is fixed to a hollow rotating shaft 43a of the driving motor 43, and a rotation angle detecting unit 45 that is composed of, for example, a rotary encoder and detects the rotation angle of the rotating portion 44. The line sensor 41 is mounted to the rotating portion 44 through a mounting portion (not shown) so as to be rotated integrally with the rotating portion 44.

The imaging unit 40 uses light to perform the supply of power to the line sensor 41 and the transmission of output signals from the line sensor 41. That is, the imaging unit 40 includes a laser light source 46 for power supply that outputs light in a predetermined wavelength band (hereinafter, referred to as a ‘first wavelength’), a dichroic prism 47, reflecting prisms 48 and 49, and a dichroic prism 50 that sequentially transmit light from the laser light source 46, and a photoelectric conversion power supply unit 51 that is composed of, for example, a solar cell, receives the transmitted light, and converts the received light into power. Power is supplied from the photoelectric conversion power supply unit 51 to the image sensor driving unit 52 such that the image sensor driving unit 52 drives the line sensor 41. The image sensor driving unit 52 drives the line sensor 41 to rotate at a predetermined angular interval on the basis of a detection signal transmitted from the rotation angle detecting unit 45 such that the line sensor 41 captures an image.

The imaging unit 40 further includes a signal processing unit 53 that processes output signals from the line sensor 41, an electro-optic conversion unit 54 that converts an electric signal output from the signal processing unit 53 into an optical signal in a wavelength band (hereinafter, referred to as a ‘second wavelength’) different from the first wavelength and outputs the optical signal, a photoelectric conversion unit 55 that receives the optical signal transmitted from the electro-optic conversion unit 54 through the dichroic prism 50, the reflecting prisms 49 and 48, and the dichroic prism 47, and converts the received optical signal into an electric signal, and a signal processing unit 56 that processes the electric signal from the photoelectric conversion unit 55 and outputs the processed signal as an image signal. The signal processing unit 53 and the electro-optic conversion unit 54 are also supplied with power from the photoelectric conversion power supply unit 51, but arrows indicating the supply of power are not shown in the drawings.

The dichroic prisms 47 and 50 include transmitting/reflecting surfaces 47a and 50a that transmit light with the first wavelength and reflect light with the second wavelength at a right angle. The laser light source 46, the dichroic prism 47, the reflecting prism 48, the photoelectric conversion unit 55, and the signal processing unit 56 are fixed to the fixed portion 42 (or the case (not shown)) by mounting portions (not shown), and the reflecting prism 49, the dichroic prism 50, the photoelectric conversion power supply unit 51, the image sensor driving unit 52, the signal processing unit 53, and the electro-optic conversion unit 54 are fixed to the rotating portion 44 by mounting portions (not shown), such that they are rotated together with the line sensor 41. The rotation angle detecting unit 45 includes a read unit and a unit to be read (not shown). One of the units is arranged on the fixed portion 42, and the other unit is arranged on the rotating portion 44.

Next, an omnidirectional imaging apparatus according to a second embodiment of the invention will be described with reference to FIG. 2. FIG. 2 is a diagram schematically illustrating the structure of the omnidirectional imaging apparatus according to the second embodiment of the invention. In FIG. 2, the same or similar components as those in the first embodiment are denoted by the same or similar reference numerals as those in FIG. 1 (alphabet A is added to the same reference numeral as that in FIG. 1).

The structure of an omnidirectional imaging apparatus 10A shown in FIG. 2 is basically similar to that of the omnidirectional imaging apparatus 10 except for the structure of an imaging optical system 20A and the arrangement direction of the imaging unit 40 (the imaging unit is arranged so as to face downward in FIG. 1, but it is arranged so as to face upward in FIG. 2).

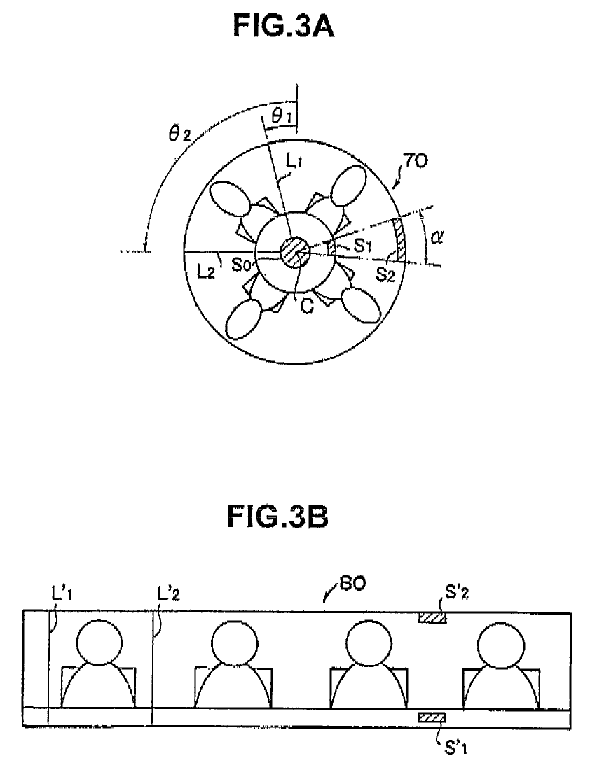

The imaging optical system 20A includes a curved mirror 22 including a reflecting surface having a spherical shaper a hyperboloidal shape, or a conic shape and an imaging lens 23. The curved mirror 22 focuses beams in all directions, and the imaging lens 23 refracts the focused beams and further focuses them, thereby forming an omnidirectional image on an imaging surface P2. Next, the operation of the omnidirectional imaging apparatus 10A according to the second embodiment of the invention will be described with reference to FIGS. 3A and 3B. FIGS. 3A and 3B have been used to describe the problems of the related art. FIG. 3A schematically shows an omnidirectional image 70 having subject information of four persons who sit around a round table, which is formed on the imaging surface P₂ when the imaging optical system 20A of the omnidirectional imaging apparatus 10A is provided on the round table such that its optical axis Z₂ is parallel to the vertical direction and a curved mirror 22 faces downward, and FIG. 3B schematically shows a panoramic image 80 of the omnidirectional image.

(1) First, the imaging optical system 20A shown in FIG. 2 forms the omnidirectional image 70 on the imaging surface P₂.

(2) Then, the line sensor 41 scans the omnidirectional image 70 to sequentially acquire the image data of the omnidirectional image 70 in all directions while rotating at a predetermined angular interval on the imaging surface P₂. Then, the line sensor 41 outputs the image data to the panoramic image forming unit 60. For example, in the omnidirectional image 70, image data on lines L₁ and L₂ respectively corresponding to azimuth angles θ₁ and θ₂ is acquired when the line sensor 41 is disposed on the lines L₁ and L₂ and then output.

(3) Then, the panoramic image forming unit 60 forms the panoramic image 80 on the basis of the image data of the omnidirectional image 70 in all directions that is sequentially acquired by the line sensor 41. In order to form the panoramic image 80, basically, the image data of the omnidirectional image 70 acquired in all directions are rearranged in parallel along the horizontal direction of the panoramic image 80 (for example, the image data in each direction that is acquired from the lines L₁ and L₂ corresponding to the azimuth angles θ₁ and θ₂ in the omnidirectional image 70 is arranged on lines L₁′ and L₂′ corresponding to the azimuth angles θ₁ and θ₂ in the panoramic image 80).

As such, the omnidirectional imaging apparatus 10A acquires the image data of the omnidirectional image 70 in all directions using the line sensor 41. Therefore, the amount of image data per unit azimuth angle in subject information within the same azimuth angle range is substantially the same, regardless of the position of an image region in a diametric direction in the omnidirectional image 70. For example, the amounts of image data per unit azimuth angle acquired from two image regions S₁ and S₂ shown in FIG. 3A (having subject information in the same azimuth angle range α) are substantially equal to each other.

Therefore, it is possible to form a high-quality panoramic image 80 over the entire image region. For example, in the panoramic image 80, there is no difference in image quality between two image regions S₁′ and S₂′ respectively corresponding to the two image regions S₁ and S₂.

The operation of the omnidirectional imaging apparatus 10A is the same as that of the omnidirectional imaging apparatus 10 according to the first embodiment of the invention, and thus a detailed description thereof will be omitted. However, the omnidirectional image 70 shown in FIG. 3A is a mirror image formed by the curved mirror 21 of the imaging optical system 20A of the omnidirectional imaging apparatus 10A, which is different from that formed by the imaging optical system 20 of the omnidirectional imaging apparatus 10.

Although the exemplary embodiments of the invention have been described in detail above, the invention is not limited thereto. Various modifications and changes of the invention can be made.

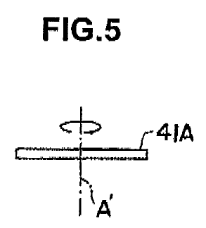

For example, in the above-described embodiments, the rotating axis A of the line sensor 41 is set at one end of the line sensor 41. However, as in a line sensor 41A shown in FIG. 5, a rotating axis A′ may be set at the center of the line sensor 41A in the length direction (at the center in the direction in which the light receiving element group is arranged). In this case, it is possible to acquire image data of the entire region of an omnidirectional image by rotating the line sensor 41A by 180 degrees to perform scanning.

In the above-described embodiments, light is used to perform both the supply of power to the line sensor and the transmission of signals from the line sensor. However, the supply of power and the transmission of signals may be performed by a wireless system. In addition, a wireless system may be used for the supply of power to the line sensor, and light may be used for the transmission of signals from the line sensor. Conversely, light may be used for the supply of power to the line sensor, and the wireless system may be used for the transmission of signals from the line sensor. Further, the supply of power to the line sensor or the transmission of signals from the line sensor may be performed by electromagnetic induction using an electromagnetic coil. When both the supply of power to the line sensor and the transmission of signals from the line sensor are performed by the wireless system, the structure of the imaging unit may be the same as that disclosed in Japanese Patent Application No. 2008-74611 applied by the applicant of the invention.

In the above-described embodiments, the line sensor 41 includes a group of light receiving elements arranged in a line. However, a line sensor (not shown) including a plurality of rows of light receiving element groups arranged in straight lines in parallel to each other may be used.

What is claimed is:

1. An omnidirectional imaging apparatus comprising:
an imaging optical system that forms an omnidirectional image having subject information in all directions radially arranged therein;
an imaging unit that acquires image data of the omnidirectional image formed by the imaging optical system; and
a panoramic image forming unit that forms a panoramic image having the subject information in all directions arranged in parallel therein, on the basis of the image data of the omnidirectional image acquired by the imaging unit,
wherein the imaging unit includes a line sensor that has a group of light receiving elements arranged in a direction orthogonal to a predetermined rotation axis and can rotate about the predetermined rotation axis to perform scanning,
the imaging unit rotates the line sensor to perform scanning, thereby sequentially acquiring the image data of the omnidirectional image in all directions, and
the panoramic image forming unit forms the panoramic image on the basis of the image data of the omnidirectional image that is sequentially acquired in all directions by the imaging unit.

2. The omnidirectional imaging apparatus according to claim 1,
wherein the imaging optical system includes a wide-angle lens that refracts beams incident in all directions and focuses the refracted beams.

3. The omnidirectional imaging apparatus according to claim 1,
wherein the imaging optical system includes a curved mirror that reflects beams incident in all directions and focuses the reflected beams.

4. The omnidirectional imaging apparatus according to claim 1,
wherein the line sensor has the predetermined rotation axis provided at the center thereof in a direction in which the light receiving element group is arranged.

5. The omnidirectional imaging apparatus according to claim 1,
wherein the imaging unit includes:
a fixed portion;
a driving motor that is provided in the fixed portion; and
a rotating portion that is fixed to a rotating shaft of the driving motor so as to be rotated with respect to the fixed portion,
the line sensor is held by the rotating portion, and
light is used for the supply of power to the line sensor and the transmission of signals from the line sensor.
